(19) United States
(12) Patent Application Publication
(10) Pub. No.: US 2010/0272549 A1
(43) Pub. Date: Oct. 28, 2010

(54) Motorized Cable-Hoisted Loading Platform and Railed Trailer

(76) Inventor: Michael Carl Petty, Bivins, TX (US)

Correspondence Address: Eugenia S. Hansen;Hemingway & Hansen, LLP, Comerica Bank Tower Suite # 2500, 1717 Main Street, Dallas, TX, 75201, US

(21) Appl. No.: 12/556,340

(22) Filed: Sep. 9, 2009

Related U.S. Application Data
(60) Provisional application No. 61/171,674, filed on Apr. 22, 2009.

(51) Int. Cl. B60P 1/64

(52) U.S. Cl. 414/500; 414/813

(57) ABSTRACT

A platform and trailer assembly which permits a user to load an object on a cargo platform at ground level and hoist the platform onto a trailer. Also, a kit for adaptation of the standard trailer is shown with the subassemblies of the trailer.

### CROSS REFERENCE TO RELATED APPLICATIONS

This application claims the benefit of U.S. Provisional Patent Application Ser. No. 61/171,674 filed on Apr. 22, 2009, under 35 U.S.C. §119(e).

### STATEMENT REGARDING FEDERALLY SPONSORED RESEARCH OR DEVELOPMENT

Not applicable.

### TECHNICAL FIELD OF INVENTION

This invention relates to the field of loading platforms and trailers for hauling objects behind a vehicle.

### BACKGROUND OF THE INVENTION

Trailers attached to cars or other vehicles are used to haul cargo or large objects. A trailer is usually attached to a vehicle via a tow hitch on the towing vehicle, which provides the user with flexibility in how or when to use the trailer because the trailer only needs to be attached to the vehicle when extra hauling capacity is needed. When no extra hauling capacity is required, the trailer and/or any equipment associated therewith can be detached from the vehicle. This ability to attach and detach the trailer also maximizes the fuel efficiency of the vehicle by removing the tow trailer from the vehicle when the trailer is not needed.

Cargo trailers typically have a metal frame supported on wheels. Some trailers are configured with a flat bed to hold cargo, while other trailers have side walls surrounding the trailer bed area. Still other trailers have an elongated tailgate, which can be positioned to become a loading/unloading ramp for the object being placed on the trailer.

Loading an object onto the trailer can be very difficult, even if a loading ramp or ramp tailgate is used. A person using a loading ramp still has to manually push or maneuver the object to be hauled up the ramp and onto the trailer. Because the object may be quite heavy or unwieldy, the manual movement of the object up the loading ramp can easily exhaust a single person, especially if the ramp has a significant incline. Moreover, the object may tilt or fall over during the loading or unloading process, which can damage the object and/or physically injure the person attempting to load or unload the object. As such, more than one person may be required to accomplish the loading or unloading of heavy objects onto or off of the trailer.

Trailer designs heretofore described have not provided for the stable and safe loading and unloading of extremely heavy objects, especially when only one person attempts to accomplish the loading or unloading. A safe and effective single person loading mechanism and trailer is needed.

### SUMMARY OF THE INVENTION

A trailer assembly which permits a user to load an object on a cargo platform at ground level over a ramp of shortened length and hoist the platform onto a railed trailer using rails and an incline front end of a cargo bed. Also, a kit for adaptation of the standard trailer is shown with the subassemblies of the trailer.

### BRIEF DESCRIPTION OF THE DRAWINGS

FIG. 1A is a perspective view of an embodiment of the trailer in the present invention with the cargo platform shown in loading position resting on the ground adjacent the trailer.

FIG. 1B is a perspective view of an embodiment of the trailer in the present invention with the cargo platform shown in the loaded towing position configuration.

FIG. 2A is a side view of an embodiment of the trailer in the present invention illustrated in FIG. 1A.

FIG. 2B is a side view of an embodiment of the trailer in the present invention as the cargo platform is being raised onto the trailer.

FIG. 2C is a side view of an embodiment of the trailer in the present invention as the cargo platform is moved along the rails on the trailer.

FIG. 2D is a side view of an embodiment of the trailer in the present invention as illustrated in FIG. 1B.

FIG. 3A is an enlarged view of trailer frame front end in the section denoted in FIG. 1A.

FIG. 3B is an enlarged view of trailer frame back end in the section denoted in FIG. 1A.

FIG. 4 is a perspective view of the parts of an embodiment of the invention, namely a kit for improving a standard trailer with the present invention.

FIG. 5 is section view of the cargo bed of FIG. 1B, along line 5-5.

### DETAILED DESCRIPTION

A mechanism and trailer for a safe and effective single person loading and unloading of cargo is shown with a motorized cable-hoisted loading and unloading of a cargo platform with an incline front end onto a railed trailer. Herein disclosed is the trailer assembly, a subassembly of a trailer, and a kit useful for adaptation of a standard trailer.

A trailer assembly 1 comprises a wheeled trailer frame 6 having a cargo bed 2. The cargo bed 2 has a top side for receiving cargo and an underside for laying flat on the ground. The cargo bed 2 is longitudinally movable from a first towing position on the trailer 1 to a second loading position on the ground behind the trailer frame 6. In said second loading position, said cargo bed 2 rests on the ground immediately to the rear of said trailer frame 6.

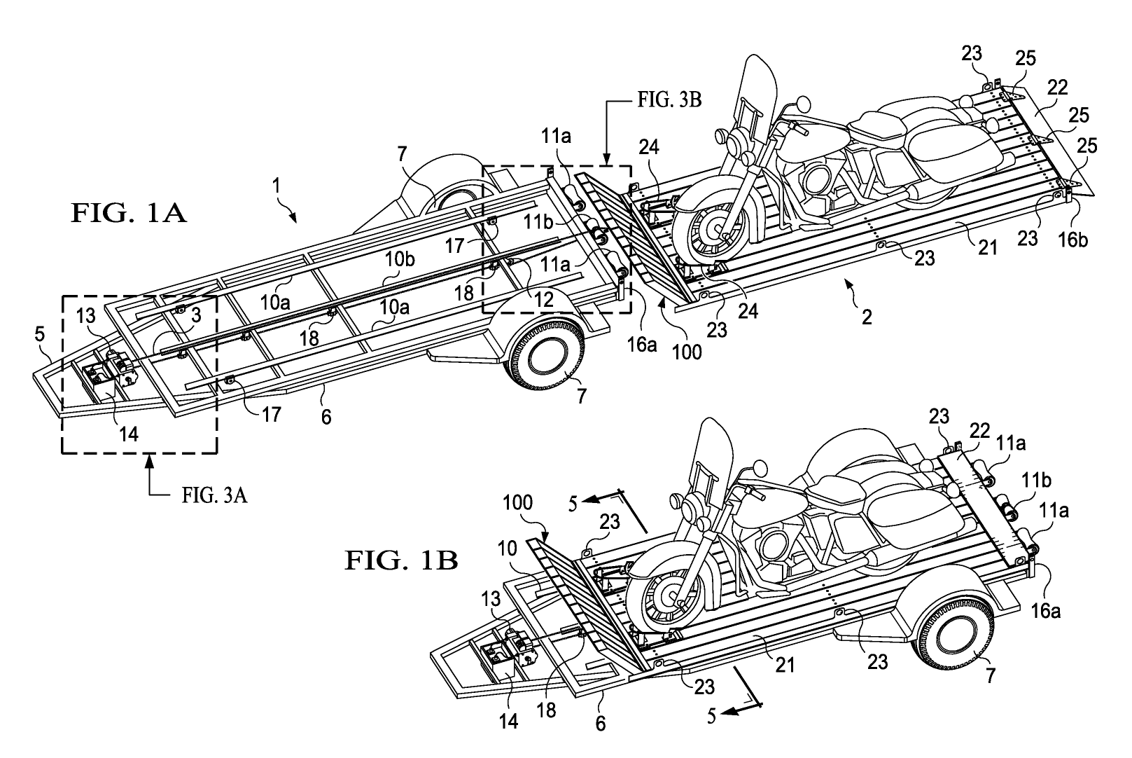

The trailer assembly also comprises a motorized mechanism 13 mounted to the trailer 1 and attached to said cargo bed 2 by a chain or cable 3 so as to facilitate longitudinal movement of the cargo bed 2 along the longitudinal length of the wheeled trailer 1 as best seen in FIG. 1A (pre-loading position) and then FIG. 1B (towing position). In a most preferred embodiment, said cargo bed 2 further comprises a short ramp 22 which is attached via hinges 25 to the back end of said cargo bed 2 and which has an unattached edge that can be placed on the ground.

Now referring to FIG. 1A, cargo bed 2 has an inclined front end 100, a back end, and two side ends. A bottom side of the cargo bed 2 is shown lying on the ground for easy loading or unloading of cargo onto the cargo bed 2.

The cargo bed 2 has a ramp 22 secured to the back end of the cargo bed by hinges 25. The unattached edge of the ramp rotates around an axis of rotation created at the attachment of the hinge 25. In a first folded up position, the ramp 22, can be positioned flat on said cargo bed 2. That is, in a first folded up position, the ramp 22 unattached edge is in temporary contact with said cargo bed. 2.

In a second folded down position, said ramp 22 has an edge that rotates about said hinges 25 and contacts the ground, which forms a shortened ramp that facilitates loading of wheeled cargo onto the cargo bed 2. The back end of cargo bed 2 has an edge dimension which is a measure of its height from ground level when the cargo bed 2 is positioned on the ground. Because the cargo bed is a matter of inches off the ground, the ramp length is shortened compare to the ramp length required to extend from ground to a position above the trailer frame.

The ramp 22 facilitates loading of wheeled cargo or cargo on a wheeled dolly to be moved onto the cargo bed 2. For example, a motorcycle, four-wheeler, and similar cargo can be driven or wheeled onto the cargo bed 2 easily during the loading procedure because the ramp height and incline are in acceptable tolerance. The loading position of the cargo bed 2 near ground level is also a safer and more level surface for loading, which provides a significant advantage over trailers must be tilted to receive cargo or loading ramps that are used with trailers that are elevated high above the ground.

The ramp 22 may be useful in the loading of heavy, wheeled cargo onto the cargo bed 2, which can roll onto the shortened distance onto cargo bed 2 via ramp 22. This is beneficial so users do not have to lift the cargo a significant vertical height onto the cargo bed 2, which is made easier because of the edge dimension of the cargo bed 2. The loading position of the trailer bed assembly 2 also prevents scraping of the bottom of the cargo using other loading mechanisms on prior trailers that require tilting for the loading process.

The cargo bed 2 front end 100 is preferably angled upwardly between 120 to 150 degrees with reference to the angle established with the bottom portion of the cargo bed 2. In FIG. 1A, angled front end 100 facilitates the process of drawing the cargo bed 2 onto trailer frame 1 whenever it is desired to place cargo bed 2 in towing position from the loading position on the ground.

Attachment bars 24 secure cargo to the cargo bed 2. For example, attachment bars 24 as illustrated in FIG. 1A are adapted to receive and secure the front tire of a motorcycle so that it may stand upright on cargo bed 2 after loading and during a towing operation. Preferably, attachment bars 24 are removably engagable to best secure the cargo being loaded and towed. The attachment bars 24 are preferably secured to front end of cargo bed 2 but may be secured elsewhere according to user applications.

Hooks or loops 23 are preferably located on both sides of the cargo bed 2 to provide a user with structures to further secure cargo. For example such loops may act as anchors for rope or straps which can be used to better secure the cargo loaded onto the cargo bed 2.

Referring to FIG. 1A, the trailer assembly 1 has a front end 5, a trailer frame 6, composed of a support of box frame construction and two wheels 7 located in wheel hubs. The wheels 7 are coupled together by an axle (not shown), and located on the trailer frame 6 are rails 10a and 10b secured to the frame by welding joints or securing brackets (not shown), said rails are positioned along a longitudinal axis that is defined along the length of the trailer 1. The rails 10a and 10b are in a “v” cross-sectional pattern, but can also be configured in a square or rail/roller wheel configuration. Rollers 11a and 11b are located at the end of the trailer 1, and the motor 13 is located at the front end of the trailer 1. Next to the motor 13 is the battery housing 14 where the battery that powers the motor 13 is located. The chain or cable 3 is shown in FIG. 1A attached to the drive sprocket assembly driven by the motor 13.

The motorized mechanism 13 drives a chain or cable 3 or combination thereof. The motorized mechanism 13 is mounted on a trailer frame 1 and the chain or cable 3 is driven therethrough. The chain or cable 3 is also connected to the front end of the cargo bed 2. As the chain or cable 3 is driven through the motorized mechanism, the cargo bed 2 moves longitudinally along a longitudinal axis of the trailer 1.

When the cargo bed 2 is placed in the loaded towing position on the trailer 1, it can also be moved longitudinally to the second position on the ground behind the trailer 1 by virtue of the motor driving the chain or cable 3. The cargo bed 2 can be moved longitudinally from the second position behind the trailer 1 to the loaded towing position on top of the trailer frame 6 with the motor 13 driving the chain or cable 3 in a second direction.

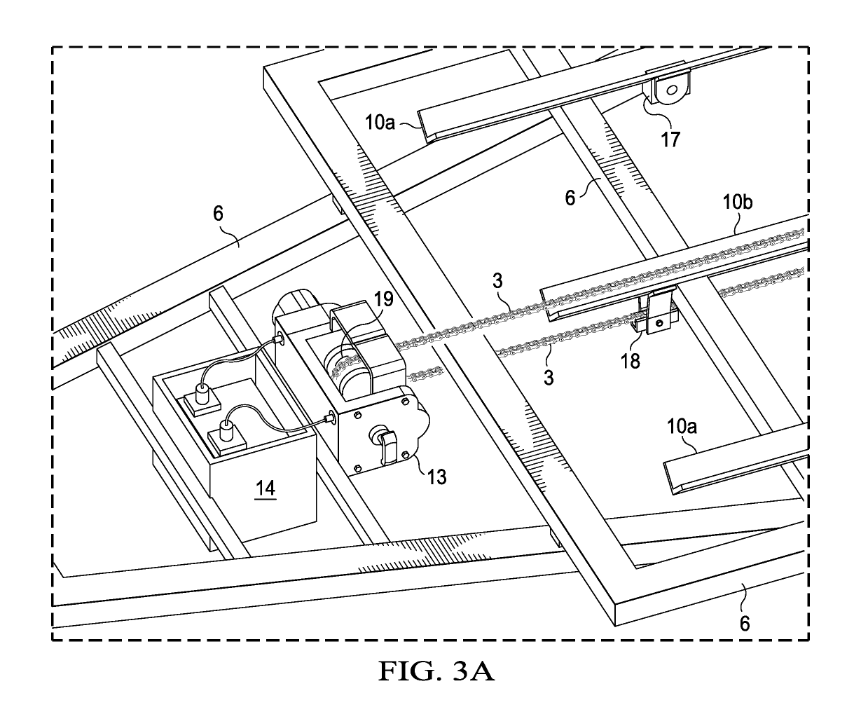

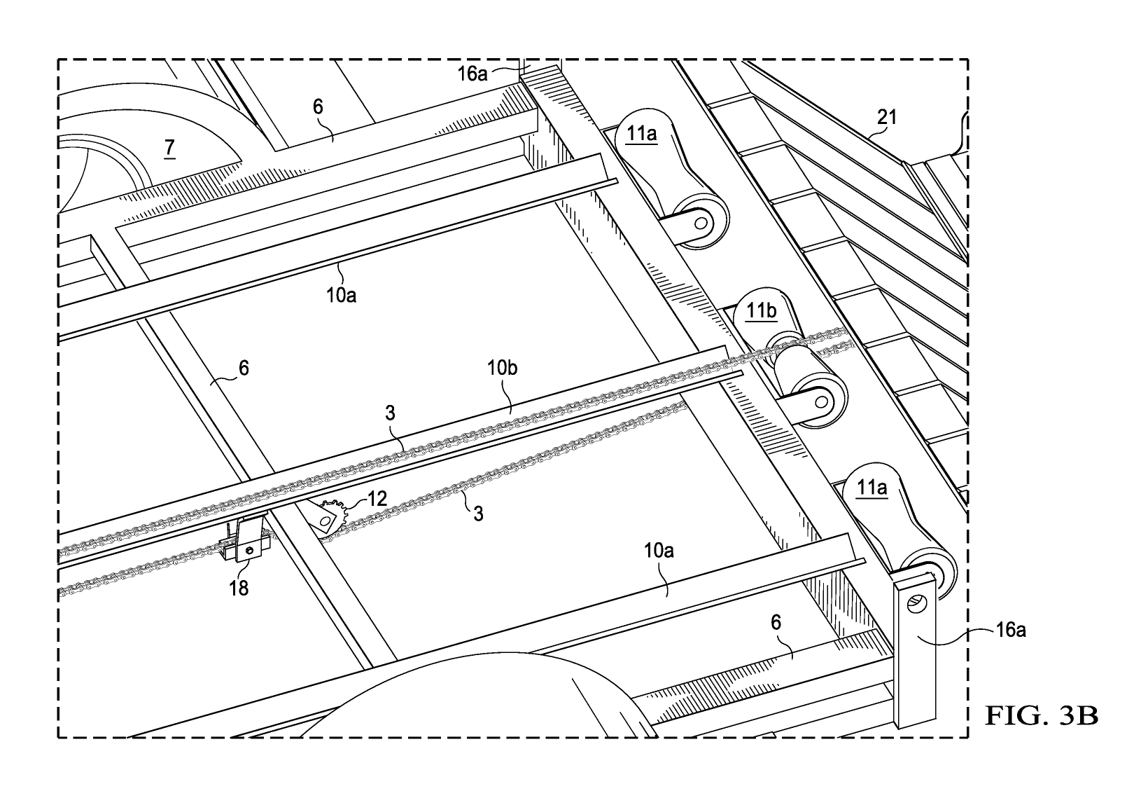

Now referring to FIG. 1B, the cargo bed 2 has been moved laterally onto a trailer frame 1 having a top side and a bottom side and a front end and a back end and two side ends. The cargo bed 2 is moved by the chain/cable 3 and driving mechanism 13 onto the trailer frame 6. The driving mechanism 13 is powered by a battery where said battery is enclosed within a fixture 14 to protect it from rain or a wet environment. This is illustrated in more detail in FIG. 3A. Overall, similar features in FIG. 1B are described above with reference to similar reference numerals in FIG. 1A.

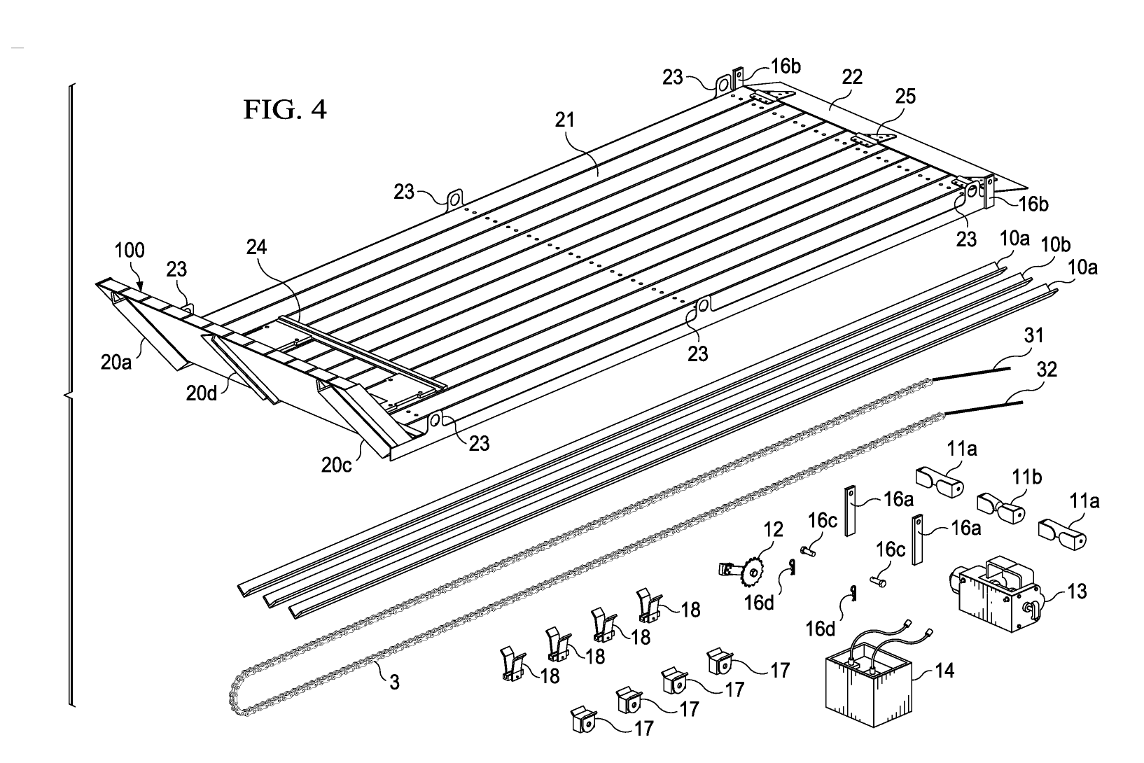

On the underside of said cargo bed are at least three cargo bed rails (not shown in FIG. 1) that are complementary to trailer rails secured to the trailer frame 10. As shown on FIG. 4, one bottom section of said cargo bed rails 20a, 20b and 20c extends from the bottom side of angled front end 100 of the bed 2 and extends longitudinally along the bottom of the cargo bed 2. In addition, cargo bed rails 20a and 20c continuously extend longitudinally along the bottom of angled front end 100. Cargo bed rail 20d is the extension of cargo bed rail 20b longitudinally along the bottom of angled front end 100. These rails (except rail 20b) are configured in a “v” cross-sectional structure, but can be configured in a square configuration or a rail and roller wheel configuration as well. Cargo bed rail 20d is preferably configured in an inverse “v” cross-sectional structure or a similar cross-sectional structure to that of cargo bed rail 20b to allow for chain or cable clearance but can be configured in a square configuration or a rail and roller wheel configuration as well.

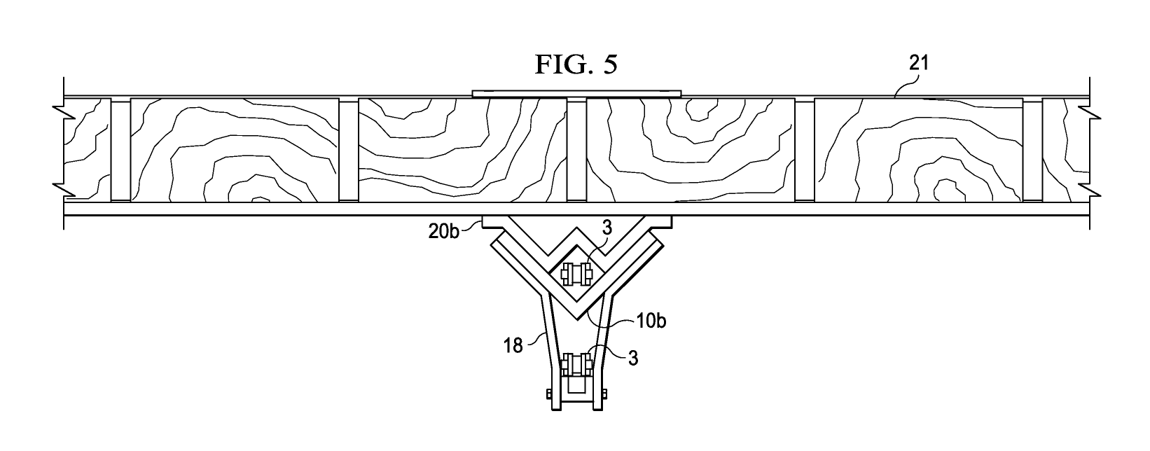

Center cargo rail 20b is further discussed in FIG. 5. A pin feature 16a through 16d may be used to help secure cargo bed 2 to trailer frame 1 while in the towing position and is illustrated in more detail in FIG. 3B.

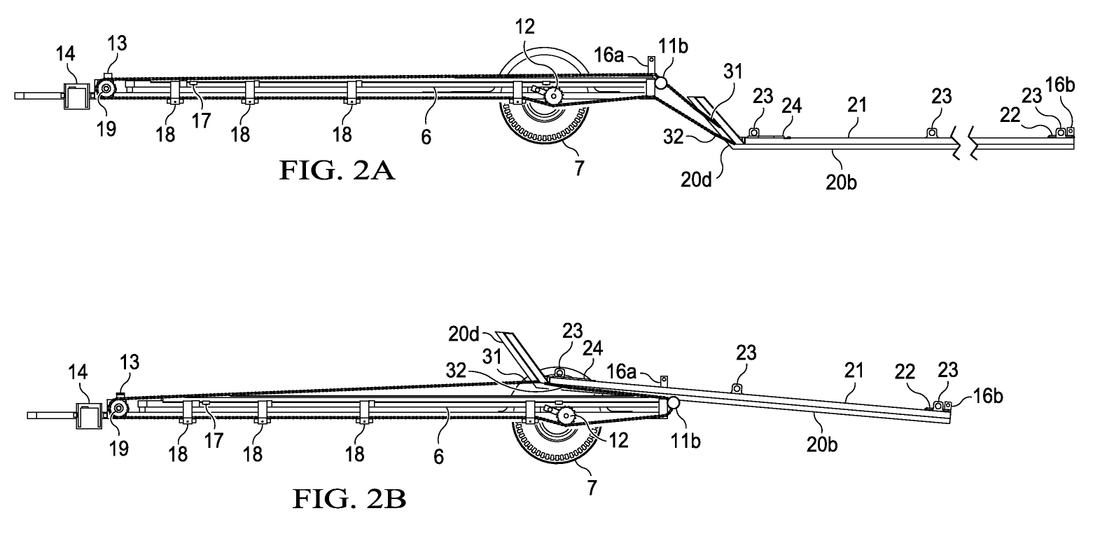

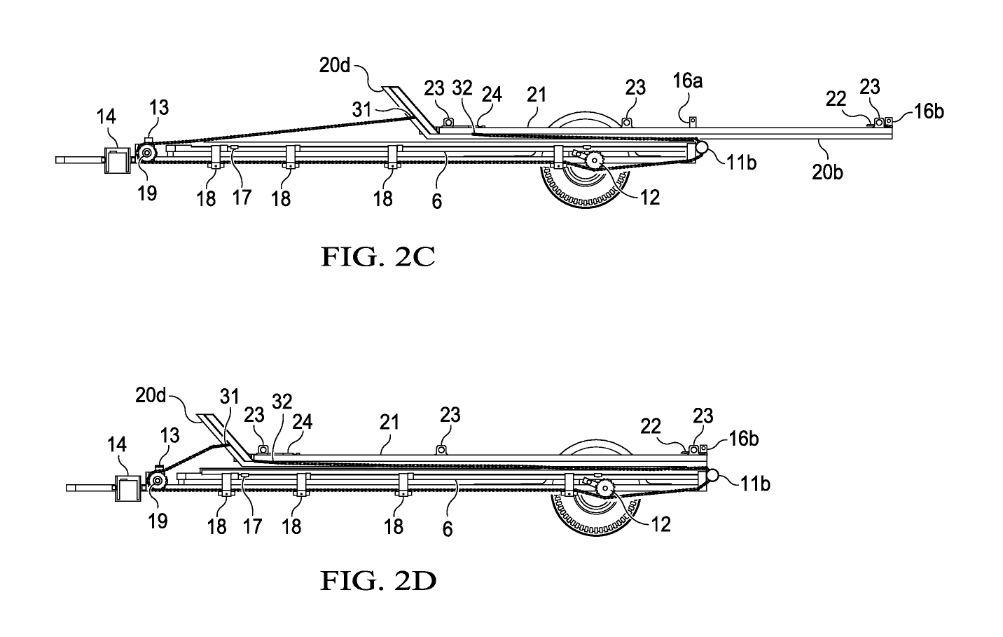

Now referring to FIG. 2A-2D, cargo bed is pulled from its loading position behind the trailer 1 into a towing position onto the trailer frame 6. In FIG. 2A, cargo bed is in loading position on the ground behind the trailer 1. When moving the cargo bed 2 from its loading position to its towing position, the ramp 22 is flipped forward to lie flat along the cargo bed 2.

The driving mechanism 13 is activated to drive the sprocket 19 to move the chain or cable 3, which pulls the cargo bed 2 towards the front end of the trailer 1. The driving mechanism or motor 13 is activated by a user to begin the transfer of the cargo bed 2 from the loading position to the towing position. The motor 13 turns the sprocket 19 counter-clockwise, when viewing sprocket as shown in FIG. 2A-2D, which in turn interlocks with the chain or cable 3 and moves it in a counter clockwise course. First chain end 31 pulls cargo bed 2 up towards top side of trailer frame.

Rollers 11a and 11b are positioned at the back end of the trailer frame 1 to assist in the moving of cargo bed 2 from loading position to towing position. The bottom side of the inclined front end 100 of the cargo bed 2 engages the rollers 11a and 11b as the chain or cable 3 pulls the cargo bed 2 onto the trailer 1. The front end 100 of the cargo bed 2 is rolled up the rollers 11a and 11b at the end of the trailer frame 6, and begins its engagement with the rails 10a and 10b on the trailer 1.

Angled front end 100 of the cargo bed 2 comes into contact with rolling supports 11a and 11b of the trailer 1 first, which helps the chain 3 to lift the angled front end 100 of the cargo bed 2 onto the back end of the trailer 1. The angled front end 100 is preferred for its ability to come into contact with the rolling supports 11a and 11b and allow chain 3 to pull cargo bed 2 up at an angle instead of straight up, which reduces the stresses on the chain itself due to aid of the rolling supports 11a and 11b.

As discussed earlier, the rollers 11a and 11b have an hourglass shape. This shape helps position each of the angled cargo bed rails 20a, 20c and 20d into the middle of each rolling support. As the angled front end 100 moves past the rolling supports 11a and 11b, the rails 20a, 20b, and 20c arranged on the bottom of the cargo bed rails as shown in FIG. 2B, become engaged with the rollers 11a and 11b.

In FIG. 2B, the cargo bed 2 continues to move past the back end of the trailer frame 6 along the rolling supports 11a and 11b secured to the trailer 6 back end. The rolling supports 11a and 11b allow cargo bed 2 to travel smoothly so as to keep the cargo bed 2 from scraping along the trailer 1 back end. The weight of the cargo bed 2 will cause the front end of the cargo bed 2 to drop down onto the trailer frame 6 as shown in FIG. 3 with the back end of the cargo bed 2 extended into the air. During this movement the rails 10a and 10b on the trailer frame 6 become engaged with the rails 20a, 20b, and 20c on the bottom of the cargo bed 2.

When the majority of the weight of the cargo on the cargo bed 2 is located above the trailer 1, the cargo bed 2 will straighten itself to this horizontal position. When shifting itself into the horizontal position as shown in FIG. 2C, the cargo bed rails 20a, 20b, and 20c will place themselves in a complementary position to the trailer rails 10a and 10b. The rolling supports 11a and 11b help the alignment of the cargo bed rails 20a, 20b, and 20c onto said trailer rails 10a and 10b by pre-aligning the cargo bed rails 20a, 20b, and 20c with the trailer rails 10a and 10b as previously discussed. The trailer rails 10a and 10b allow cargo bed 2 to continue moving longitudinally onto trailer 1.

In FIG. 2C, the rails 20a, 20b, and 20c on the bottom of the cargo bed 2 engage with rails 10a and 10b on the trailer frame 6, as the motor 13 continues to be activated. The cargo bed 2 slides further up the longitudinal axis of the trailer 1 as the cable or chain 3 is pulled by the motor 13. The cargo bed 2 continues to slide toward front end of trailer frame until user turns off the driving mechanism 13. FIG. 2D shows the cargo bed 2 in the fully loaded towing position on the trailer frame 6.

As the frame is slid up the rails 10a and 10b, the middle rail 20b on the bottom of the cargo bed 2 becomes engaged with the rail 10b. The back end of the chain or cable 3 that is attached to the front of the cargo bed 2 will lie underneath the cargo bed 2 in this loaded towing position as it is slid longitudinally up the trailer frame 6. The rail 20b is formed with a clearance slit to keep the rails 20b and 10b from pinching the chain or cable 2. The trailer rails 10a and 10b are affixed by welding joints or brackets (not shown) to the trailer frame 6, so the cargo bed 2 slides smoothly toward the front end of trailer frame.

This process continues until the cargo bed 2 is moved all the way up the trailer 1 to its towing position. When cargo bed 2 is in the towing position as shown in FIG. 2D, pins 16c are placed within pin guides 16a and 16b and secured in place with a pin clamp 16d to secure cargo bed 2 to trailer frame 1. Pin feature 16a through 16d is further detailed in description of FIG. 3B.

To move the cargo bed 2 from the towing position to the loading position, the driving mechanism or motor 13 is activated in the opposite direction. For example when viewing sprocket and chain as shown in FIG. 2A-2D, the motor 13 turns the sprocket 19 clockwise which in turn interlocks with the chain 3 and moves it in a clockwise course. This chain would be placed in a clearance slit between rails 10b and 20b shown in FIG. 5. In this situation, the second chain end 32 would pull the cargo bed 2 back toward back end of trailer frame. The cargo bed 2 would move longitudinally the reverse course of that described previously and shown from FIG. 2D to FIG. 2A.

The other components of the system are also described with reference to a battery powered motor or driving mechanism 13 that is used to move the cargo bed 2 longitudinally from a first towing position to a second loading position. Trailer rails 10a and 10b are secured to the trailer frame 1 to compliment the cargo bed rails 20a, 20b and 20c which together keep the cargo bed 2 situated on top of trailer frame 1. The rails 10a and 10b are in a “v” cross-sectional pattern, but can also be configured in a square or rail/roller wheel configuration. Rails 20a and 20c are configured in a “v” cross-sectional structure and 20b is configured in a “w” configuration, but can be configured in a square configuration or a rail and roller wheel configuration as well.

A friction reducing material 17 for example Teflon®, can be placed in the “v” formation of the trailer rails 10a and 10b to aide in the sliding of the cargo bed rails 20a, 20b, and 20c within the trailer rails 10a and 10b. Brackets 18 may be secured on underside of center trailer rail 10b of trailer frame 1 to help guide the chain or cable 3 slack on the underside of the trailer frame 6. Additionally, a chain tensioner 12 may also be secured to underside of trailer frame 6 along center trailer rail 10b to keep the chain or cable 3 taut.

A pin feature 16a through 16d may be secured to the trailer to aide in securing the cargo bed 2 to the trailer frame 1 while in the towing position. FIGS. 1A to 6 show pin feature 16a through 16d near back end of trailer, but it may be positioned anywhere that allows pin guides 16a and 16b to align so that pin 16c may pass through and be secured by pin clamp 16d. Pin feature 16a through 16d aides in securing cargo bed 2 to trailer frame 1 while in the towing position and is further detailed in description of FIG. 3B.

Various loops 23 are also positioned to both sides of cargo bed 2. Said loops 23 provide user an anchor to tie down cargo placed on top of cargo bed 2 with rope, straps, or other cargo securing devices. Attachment bars 24 also aide in securing the cargo. These attachment bars 24 may be interchanged to suit the cargo.

Now referring to FIG. 3A, the driving mechanism 13 for the chain or cable 3 is shown. In the preferred embodiment the driving mechanism is a motor powered by a battery. Another embodiment may move the chain or cable 3 by a manual user powered driving mechanism, for example a hand-driven crank. Or, the chain or cable 3 may be moved by an electrical-powered motor that can be plugged into a socket or a gas-powered motor run by a generator or gas powered engine.

A preferred driving mechanism is a motor that can rotate its shaft in a clockwise and counter-clockwise motion. The shaft of the motor 13 rotates a sprocket 19 that engages the chain or cable 3 attached to cargo bed 2. The friction reducing material 17 such as Teflon®, can be placed in the grooves of rails 10 to allow cargo bed 2 to extend out or retract smoother and with greater ease.

FIGS. 1A through 3B show the path of a chain or cable around trailer frame. Chain or cable 3 has both ends secured to cargo bed 2 directly to or near rail 20d. With cargo bed is in the loading position, the front chain end 31 secures to or near center cargo bed rail 20d, wraps around slotted roller 11a, and travels along inside of center trailer rail 10a toward front end of trailer 1 and through the sprocket 19 of the driving mechanism 13. The chain or cable 3 then wraps around said sprocket 19 and travels towards back end or trailer frame 1. Another type of sprocket-device may be used if a cable 3 is used instead of a chain 3.

Along the underside of trailer frame 6, the chain or cable 3 travels through various guides in the bracket 18 and chain or cable tensioner 12 as shown in FIG. 3B, where the second chain end 32 attaches to the front end of the cargo bed 2 near the center cargo bed rail 20d.

Now referring to FIG. 3B, the rolling supports 11a and 11b aid in the moving of the cargo bed from the loading position to the towing position and back. The rolling supports 11a and 11b, which are secured to back end of trailer frame 1, are preferably of a horizontal hourglass shape to assist in properly guiding the cargo bed 2 onto the rails 10 by limiting lateral (side-to-side) movement while the trailer is pulled along the longitudinal axis of the trailer frame 6. The rolling supports 11a and 11b also allow said cargo bed to be pulled onto said trailer smoothly so as to keep the bed from scraping along the trailer frame 1 back end. The center rolling support 11b preferably has a deep groove or additional slotting radially in the center area to accommodate the chain or cable 3.

A chain or cable tensioner 12 helps keep the chain or cable taut while bracket 18 prevents lateral movement of the chain while it is being used. Rails 10a and 10b which are secured to trailer frame 6 by welding joints or brackets (not shown) receive rails 20a, 20b and 20c on the bottom of said cargo bed to guide the cargo bed 2 onto the trailer.

Trailer frame pin guides 16a are secured to trailer frame 6 side ends preferably near the back end thereof. Cargo bed pin guides 16b are secured to cargo bed 2 preferably near the back end thereof. The material of pin guides 16a and 16b defines a hole adapted to receive a pin or peg to better secure the bed to the trailer frame. The hole defined by cargo bed pin guide 16a aligns with the hole defined by cargo bed pin guide 16b in the towing position. A pin 16c, which may be separate or attached via a cord or chain to said trailer frame 6, can be inserted into both holes when they are aligned to help secure said cargo bed 2 to trailer 1 when in the towing position. A pin clamp 16d can be used to help secure pin 16c inside both holes.

Now referring to FIG. 4, a kit for adapting a standard trailer comprises individual parts shown. These are to be added to an existing trailer frame 6. These parts are preferably supplied as a kit with instructions and are to be installed by a user on an existing trailer. Parts may also be preinstalled on a trailer offered for sale as a unitary product.

The kit comprises a cargo bed 2 which may comprise wooden boards 21 secured by metal framing, cargo bed rails 20a, 20b, and 20c as previously discussed, loops 23 which may be defined by the metal framing, attachment bars 24, cargo bed pin guides 16b, and a ramp 22 which is secured to cargo bed 2 by hinge mounts 25. Alternatively, one or more parts of cargo bed 2 may be provided and a user given instructions for construction thereof. Alternate embodiments may comprise composite, plastic or other materials used for the board material that retains the structural integrity.

The kit further comprises parts used for adaptation of a trailer frame. FIGS. 1-4. These are to be mounted to a trailer of the user's selection as shown in FIG. 1A. Some of the parts installed above can be omitted or additional parts are within the scope of the invention as shown in FIGS. 1-4. These parts include the trailer rails 10 as previously discussed, rollers 11 which are secured to back side of trailer frame 1, trailer frame pin guides 16a, a driving motor 13 and a battery enclosure 14 with battery.

Brackets 18 are to be secured to underside of center trailer rail 10b. A friction reducing material 17 is secured to trailer rails 10a and 10b (not shown on 10b). A chain tensioner 12 may be secured to trailer frame 6 or underside of center trailer rail 10a. Additionally, any pin 16c and pin clamp 16d may be used in conjunction with pin guides 16a and 16b.

Now referring to FIG. 5, a cross-sectional view of the preferred embodiment shows the center cargo rail 20b stationed within the center trailer rail 10a while in the towing position. The rails provide the cargo bed 2 a means to slide longitudinally back and forth from the towing position to the loading position and back without lateral movement. The rails also keep the cargo bed situated when in the towing position.

In the preferred embodiment, the center cargo bed rail 10b is shaped like a “w” to allow space for the chain or cable 3 to pass between said cargo bed rail 20b and “v” shaped center trailer rail 10b. This is needed to allow chain or cable 3 to move freely while cargo bed 2 is traveling on top of trailer 1. As the frame is slid up onto the rails 10a and 10b, the middle rail 20b on the bottom of the cargo bed 2 becomes engaged with the rail 10b.

The second chain end 32 of the chain or cable 3 that is attached to the front of the cargo bed 2 will lie underneath the cargo bed 2 as it is slid longitudinally, up the trailer 1. The rail 20b is formed with a clearance slit to keep the rails 20b and 10b from prinking the chain or cable 2.

Various brackets 18 are secured to the underside of center trailer rail 10b to aide in reducing chain or cable slack. The rails 10a and 10b are in a “v” cross-sectional pattern, but can also be configured in a square or rail/roller wheel configuration. Rail 20b is configured in a “w” cross-sectional structure, but can be configured in a square configuration or a rail and roller wheel configuration as well where a clearance slit is provided.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and various as fall within the true spirit and scope of the invention. In addition, provisional patent application 61/171,674 filed on Apr. 22, 2009, to which this application claims the benefit of under 35 U.S.C. §119(e) is herein incorporated by reference.

I claim:

1. A cargo trailer assembly comprising:
a trailer frame that extends along a longitudinal axis of the trailer assembly, having attached to the trailer frame at least two wheels that roll a manner aligned with the longitudinal axis of the trailer, said trailer frame can be removably attached to a vehicle for towing a cargo object;
a cargo platform that can be positioned on the ground proximate to the trailer frame or on top of the trailer frame, said cargo platform securely holding said cargo object on top of the cargo platform to and said cargo platform having an inclined front end;
one or more rollers positioned at the end of the trailer to engage the inclined front end of the cargo platform as the cargo platform is moved longitudinally on the trailer frame;
a plurality of rails longitudinally positioned on said trailer is to slideably engage reciprocal rails positioned on the bottom of the cargo platform as the cargo platform moves longitudinally on the trailer frame, and,
a driving mechanism positioned on the trailer frame for driving an attachment cable around a drive axle of the driving mechanism, said cable connected to the front end of the cargo platform to hoist the cargo platform longitudinally on the trailer frame.

2. The claimed apparatus in claim 1 wherein the rails on the trailer frame are configured in a “v” configuration.

3. The claimed apparatus in claim 1 wherein the rails on the trailer frame equal 3 rails.

4. The claimed apparatus in claim 1 wherein the center rail on the cargo bed is configured in a “w” configuration.

5. The claimed apparatus in claim 1 wherein the rollers on the back of the trailer equal 3 rollers.

6. The claimed apparatus in claim 1 wherein the cargo bed rails are configured in a “v” shape to assist with the slideable engagement with the loading platform.

7. A cargo trailer assembly comprising:
a trailer frame that extends along a longitudinal axis of the trailer assembly, having attached to the trailer frame at least two wheels that roll in a manner aligned with the longitudinal axis of the trailer, said trailer frame can be removably attached to a vehicle for towing a cargo object;
a cargo platform having a flat bottom portion and an inclined front end, said cargo platform that can be positioned on the ground proximate to the trailer frame or on top of the trailer frame, and said cargo platform securely holding a cargo object on top of the cargo platform;
one or more rollers positioned at the end of the trailer to engage the front and bottom portion of the cargo platform as the cargo platform is moved onto or off of the trailer frame;
a plurality of rails longitudinally positioned on said trailer to slideably engage reciprocal rails positioned on the bottom of the cargo platform as the cargo platform moves onto or off of the trailer, and,
a driving mechanism positioned on the trailer for driving an attachment cable around a drive axle of the driving mechanism, said cable connected to the front end of the cargo platform to hoist the cargo platform onto the trailer frame using the inclined front end of the cargo platform, the trailer rollers and the reciprocal rails positioned on the trailer frame and the bottom of the cargo platform.

8. The claimed apparatus in claim 7 wherein the rails on the trailer frame are configured in a “v” configuration.

9. The claimed apparatus in claim 7 wherein the rails on the trailer frame equal 3 rails.

10. The claimed apparatus in claim 7 wherein the center rail on the cargo bed is configured in a “w” configuration.

11. The claimed apparatus in claim 7 wherein the rollers on the back of the trailer equal 3 rollers.

12. The claimed apparatus in claim 7 wherein the cargo bed rails are configured in a “v” shape to assist with the slideable engagement with the loading platform

13. A method of loading a trailer assembly comprising:
providing a trailer having a trailer frame, at least two wheels and a longitudinal axis, said trailer can be removably attached to a vehicle for towing a cargo object;
attaching a cargo platform to a chain assembly, said cargo platform can be positioned on the ground behind the trailer, said cargo platform holding a cargo object on top of the cargo platform;
attaching a driving mechanism drive sprocket to the chain assembly, said driving mechanism being positioned on the trailer, the opposite end of the chain being connected to the front end of the cargo platform;
activating the driving mechanism to move the cargo platform into the loaded position on the trailer assembly,
engaging the front and bottom portion of the cargo platform across one or more rollers positioned at the end of the trailer as the cargo platform is moved onto or off of the trailer; and
engaging a plurality of rails longitudinally positioned on said trailer to slide the bottom of the cargo platform across the trailer frame.

14. The claimed method of claim 13 wherein the rails of the trailer frame are configured in a “v” configuration.

15. The claimed method of claim 13 wherein the rails on the trailer frame equal 3 rails.

16. The claimed method of claim 13 wherein the center rail on the cargo bed is configured in a “w” configuration.

17. The claimed method of claim 13 wherein the rollers on the back of the trailer equal 3 rollers.

18. The claimed method of claim 13 wherein the front part of the loading platform is inclined to assist with the engagement of the platform with the rollers at the end of the trailer.

19. The claimed method of claim 13 wherein the rails are configured in a “v” shape to assist with the slideable engagement with the loading platform.

20. The claimed method of claim 13 wherein the chain can be a cable-based attachment mechanism.
